(19) United States
(12) Patent Application Publication
(10) Pub. No.: US 2007/0144046 A1
(43) Pub. Date: Jun. 28, 2007

(54) Modular display board

(76) Inventor: John C. Hardt II, Belton, TX (US)

Correspondence Address: NATH & ASSOCIATES, PLLC, 112 South West Street, Alexandria, VA, 22314, US

(21) Appl. No.: 11/315,308

(22) Filed: Dec. 23, 2005

(51) Int. Cl. G09F 7/00

(52) U.S. Cl. 40/605

(57) ABSTRACT

Disclosed herein is a display board having at least one hollow panel, which has a rear surface and a front surface; the hollow panel has a ridge along at least one edge of the hollow panel and includes a channel that is interlockable with a ridge of a second panel. An embodiment of the display board can include a plurality of interlocking panels releasably attached to each other. In this embodiment, each of the plurality of interlocking panels includes a joint engaging member along at least one of its edges for interlocking it to another interlocking panel. Another embodiment of the display board includes a blow-molded panel having a ship-lapped groove on at least one of its edges. The ship-lapped groove of the blow-molded panel is configured to interlock with a ship-lapped groove of another panel. A further embodiment of the display board includes a plurality of separable sections. Each of the separable sections includes an interlocking mechanism and a rail along at least one edge of a face of the separable section.

### FIELD OF INVENTION

This application discloses a modular panel usable as a writing board or other display apparatus.

### SUMMARY

An embodiment of the modular display board can include at least one hollow panel that has a rear surface and a front surface. The hollow panel has a ridge, which includes a channel, along at least one of its edges. The ridge, through the channel, is interlockable with a ridge of another panel. The modular display board can be made hollow by various blow molding techniques.

When the modular display board is used as a writing board, a dry-erasable material, blackboard material, paper, or other writing surface can be added to the front surface; or the front panel can be made of any of these materials, singularly or in combination with each other. When the modular display board is used as a display board, without a writing surface, a tack surface such as cork, pressure sensitive adhesive, felt, or any other material to which foreign items can be attached, can be added to the front surface of the modular display board; or the front surface can be made of any of these materials, singularly or in combination with each other. Also, the writing surface can be used in conjunction with the tack surface.

Embodiments of the modular display board can also include a plurality of secondary panels. The hollow panel and at least one of the secondary panels can each comprise a separate corner section of the display board. For example, a modular board having four panels will be configured such that one of the corners of each of the four panels will be a corner of the assembled modular board. Embodiments of the modular display board having more than four panels will have inner sections made up of tertiary panels where four of the panels are configured such that one of the corners of each of the four panels is a corner of the assembled board and the tertiary panels are positioned between and inside each of the corner sections. For example, a modular display board having two rows and three columns will have four corner sections and two inner sections. The inner sections are the tertiary panels.

Edges of the hollow panel of this embodiment of the modular display board can have a rim that can be configured such that at least one part of the rim has a retaining lip for receiving a dry-erasable surface. Additionally, at least one part of the rim can include a recess adapted to be a handle for the display board. The part of the rim having the handle can be either the same part of the rim as that having the retaining lip or the part of the rim having the handle can be a part other than the part of the rim having the retaining lip.

The rear surface of the modular display board can be planar or can include at least one indentation. The indentation can be usable as a storage space, mounting recess, or a handle for holding the modular display board by the rear surface.

An additional embodiment of the modular display board includes a plurality of interlocking panels that are releasably attached to each other. Each of the interlocking panels should include a joint engaging member along at least one of its edges. The joint engaging member should be configured such that it helps to interlock its panel with another panel.

At least one of the panels of this embodiment of the modular display board can have three layers—a front layer and a rear layer sandwiching an inner air layer.

When this embodiment of the modular display board is used as a writing board, a dry-erasable material, blackboard material, paper, or other writing surface can be added to the front surface; or the front surface can be made of any of these materials, singularly or in combination with each other. When this embodiment of the modular display board is used as a display board, without a writing surface, a tack surface such as cork, pressure sensitive adhesive, felt, or any other material to which foreign items can be attached, can be attached to the front surface of the modular display board; or the front surface can be made of any of these materials, singularly or in combination with each other. Also, the writing surface can be used in conjunction with the tack surface.

The rear surface of this embodiment of the modular display board can be planar or can include a channeled cross section such that, when looked at from its edge, the cross-section includes peaks, valleys and even linear sections. The locations of the peaks, valleys, and linear sections in the cross-section can vary around the area of the rear surface. With this variance in locations of peaks, valleys, and linear sections, different indentations can be formed in the rear surface so that the channeled areas of the rear surface of this embodiment of the modular display board can be used as a storage space, mounting recess, or a handle for holding the modular display board by the rear surface.

Each of the interlocking panels of this embodiment of the modular display board can act as a separate corner section of the modular display board. For example, a modular board having four panels will be configured such that one of the corners of each of the four panels will be a corner of the assembled modular board; or a modular board having two panels will be configured such that two of the corners of one panel are two of the corners of the assembled board and two of the corners of the remaining panel are the other two corners of the assembled modular board. This embodiment of the modular display board can be used with edge sections and inner sections made up of additional interlocking panels. The edge sections can be placed between two end panels thereby creating an elongated modular display board; or the edge sections can be placed between four corner interlocking panels as edges. The interior sections of the modular display board can be placed inside the four corner sections and edge sections of the modular display board.

Edges of the interlocking panels of this embodiment of the modular display board can also be configured such that at least one edge has a retaining lip for receiving a dry-erasable surface. Additionally, at least one of the edges can include a recess adapted to be a handle for the display board. The edge having the handle can be either the same edge as the edge having the retaining lip or the edge having the handle can be an edge other than the edge having the retaining lip.

A further embodiment of the modular display board includes a first blow-molded panel having a ship-lapped groove on the panel's edge. The ship-lapped groove of the first blow-molded panel can be adapted to interlockingly connect with a ship-lapped groove of a second panel. The first blow-molded panel of this embodiment of the modular display board can have a front layer and an indented rear layer.

When this embodiment of the modular display board is used as a writing board, a dry-erasable material, blackboard material, paper, or other writing surface can be added to the front layer; or the front layer can be made of any of these materials, singularly or in combination with each other. When this embodiment of the modular display board is used as a display board, without a writing surface, a tack surface such as cork, pressure sensitive adhesive, felt, or any other material to which foreign items can be attached, can be attached to the front layer of the modular display board; or the front layer can be made of any of these materials, singularly or in combination with each other. Also, the writing surface can be used in conjunction with the tack surface.

The first blow-molded panel of this embodiment of the modular display board can act as a corner section of the modular display board. Additional blow-molded panels can be attached to the first blow-molded panel to create a multi-panel board. Some of the additional panels can be attached to the first blow-molded panel to serve as inner sections of this embodiment of the modular display board. For example, a modular board having four panels will be configured such that one of the corners of each of the four panels will be a corner of the assembled modular board; or a modular board having two panels will be configured such that two of the corners of one panel are two of the corners of the assembled board and two of the corners of the remaining panel are the other two corners of the assembled modular board. In this embodiment of the modular display board, edge sections can be placed between two end panels thereby creating an elongated modular display board; or the edge sections can be placed between four corner panels as display board edges. The interior sections of the modular display board can be placed inside the four corner sections and edge sections of the modular display board.

As with previous embodiments, edges of the first blow-molded panel of this further embodiment of the modular display board can also be configured such that at least one edge has a retaining lip for receiving a dry-erasable surface. Additionally, at least one of the edges can include a recess adapted to be a handle for the display board. The edge having the handle can be either the same edge as the edge having the retaining lip or the edge having the handle can be an edge other than the edge having the retaining lip.

An additional embodiment of the modular display board is one that includes a plurality of separable sections. Each of the separable sections can include an interlocking mechanism. The separable sections can also each have a face that can include a rail along at least one of the edges of the face.

When this embodiment of the modular display board is used as a writing board, a dry-erasable material, blackboard material, paper, or other writing surface can be attached to an attachment ridge. The attachment ridge is substantially near the edge of the face of at least one of the separable sections. The writing surface can be added to the face of at least one of the separable sections and held in place by the attachment ridge. Or, the face of at least one of the separable sections can be made of any of these materials, singularly or in combination with each other. Additionally, at least one of the edges of the separable sections can include a recess adapted to be a handle for the display board. The edge having the handle can be either the same edge as the edge substantially near the attachment ridge or the edge having the handle can be an edge other than the edge substantially near the retaining lip.

When this embodiment of the modular display board is used as a display board, without a writing surface, a tack surface such as cork, pressure sensitive adhesive, felt, or any other material to which foreign items can be attached, can be attached to the face of one of the separable sections of the modular display board; or the front layer can be made of any of these materials, singularly or in combination with each other. Also, the writing surface can be used in conjunction with the tack surface.

At least one of the separable sections of this embodiment of the modular display board can have three layers—a front layer and a rear layer sandwiching an inner air layer.

The rear layer of this embodiment of the modular display board can be planar or can include an irregular cross-section such that, when looked at from its edge, includes peaks, valleys and linear sections. The locations of the peaks, valleys, and linear sections in the cross-section can vary around the area of the rear layer. With this variance in locations of peaks, valleys, and linear sections, different indentations can be formed in the rear layer so that the irregular areas of the rear layer of this embodiment of the modular display board can be used as a storage space, mounting recess, or a handle for holding the modular display board by the rear layer.

At least one of the separable sections of this embodiment of the modular display board can act as a corner section of the modular display board. Other separable sections can be attached to the first separable section to create a multi-panel board. Yet additional separable sections can be attached to the first separable section to serve as inner sections of this embodiment of the modular display board. For example, a modular board having four separable sections will be configured such that one of the corners of each of the separable sections will be a corner of the assembled modular board; or a modular board having two separable sections will be configured such that two of the corners of one separable section are two of the corners of the assembled board and two of the corners of the remaining separable sections are the other two corners of the assembled modular board. In this embodiment of the modular display board, edge sections can be placed between two end separable sections thereby creating an elongated modular display board; or the edge sections can be placed between four corner separable sections as display board edges. The interior sections of the modular display board can be placed inside the four corner sections and edge sections of the modular display board.

### BRIEF DESCRIPTION OF THE DRAWINGS

FIG. 1a shows an embodiment of the modular display board;

FIG. 1b shows a rear surface of the modular display board of FIG. 1a;

FIG. 2 shows a panel of the modular display board;

FIG. 3 shows a panel configured as a corner section of the modular display board;

FIG. 4 shows an embodiment of the modular display board having inner sections;

FIG. 5a shows an exploded view of the writing board of FIG. 1 having an attached writing surface and tack surface;

FIG. 5b shows an exploded view of the rear surface of the modular display board of FIG. 5a;

FIGS. 6a-6b show a rear surface of the modular display board;

FIG. 7a shows a corner portion of a modular display board;

FIG. 7b shows an interior portion of a modular display board;

FIG. 7c shows the locking ridge of FIGS. 7a and 7b in communication with a locking ridge of a secondary panel;

FIG. 8 shows a rear perspective cross-sectional view of a hollow panel of the modular display board;

FIG. 9 shows a front perspective cross-sectional view of the hollow panel of FIG. 8;

FIG. 10 shows a cross-sectional view of a rim of the panel shown in FIG. 3;

FIG. 11a shows a modular display board having four corner panels;

FIG. 11b shows a modular display board having only two end panels; and

FIG. 11c shows a modular display board having two end panels and a plurality of interior panels.

### DESCRIPTION OF THE EMBODIMENTS

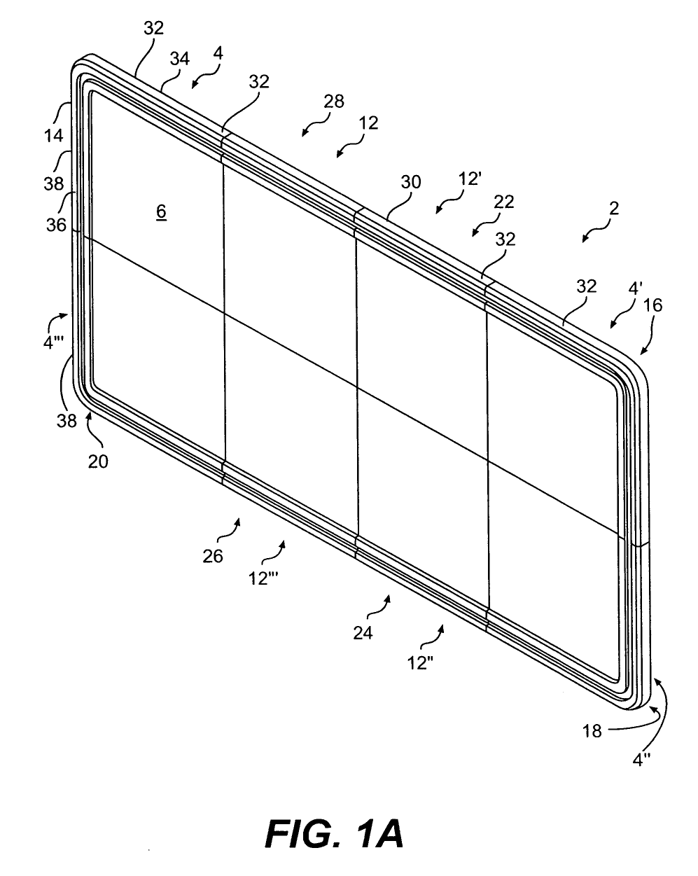

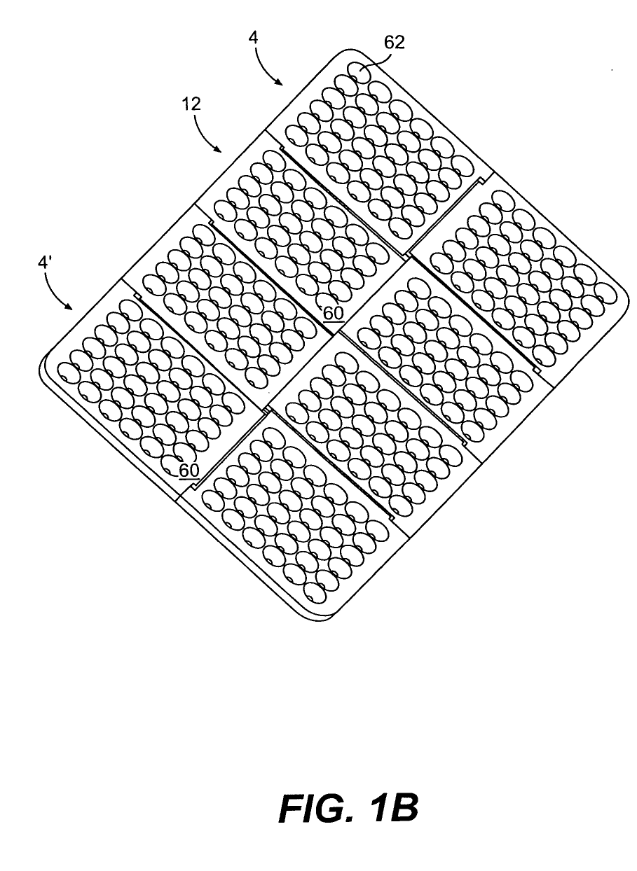

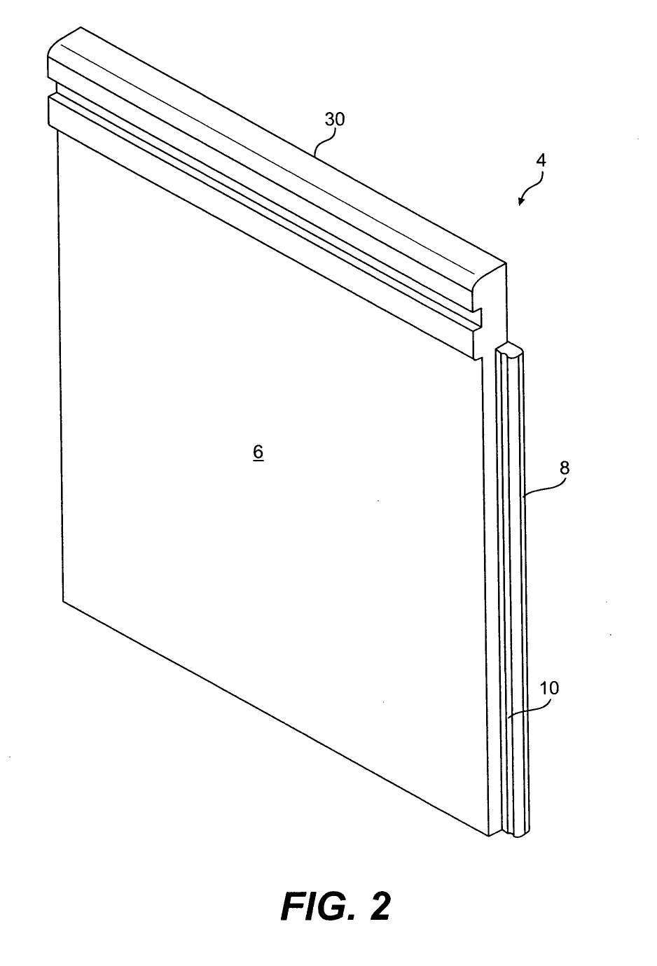

An embodiment of the modular display board 2 is shown in FIGS. 1a, 1b and 2. The modular display board 2 includes at least one hollow panel 4 that has a rear surface 60, a front surface 6, and a ridge 8, which includes a channel 10, along at least one of the panel's edges. The ridge 8, through the channel 10, is interlockable with a ridge of another (secondary) panel 12. The modular display board 2 can be made hollow by various blow molding techniques.

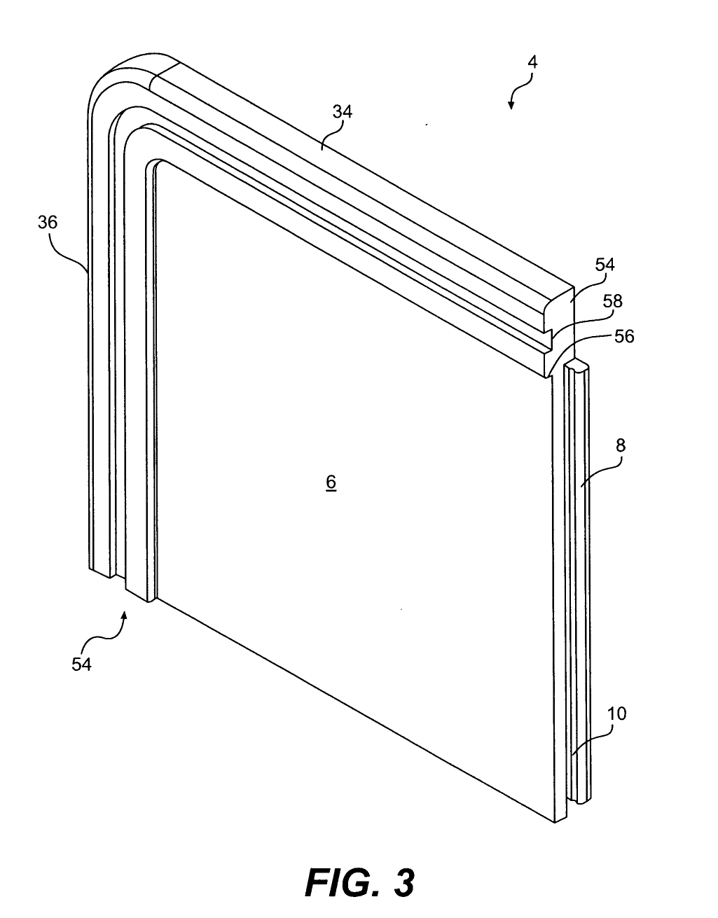

The hollow panel 4 and additional hollow panels 4′, 4″ and 4′″ can each constitute a separate corner section 14, 16, 18, or 20 of the modular display board 2. Also, the secondary panel 12 and additional secondary panels 12′, 12″, and 12′″ can be added to the hollow panels 4-4′″ to constitute edge sections 22, 24, 26 and 28 of the modular display board 2. In this type of configuration, one of the edges 34 and a second edge 36 of corner section 14, 16, 18, or 20, respectively, act as part of a first edge 32 and a second edge 38 of the modular display panel 2. And, one of the edges 30 of the edge sections 22, 24, 26 or 28 will each act as a part of one of the edges 32 of the modular display panel 2. FIG. 3 shows hollow panel 4 configured as corner section 14 with greater particularity.

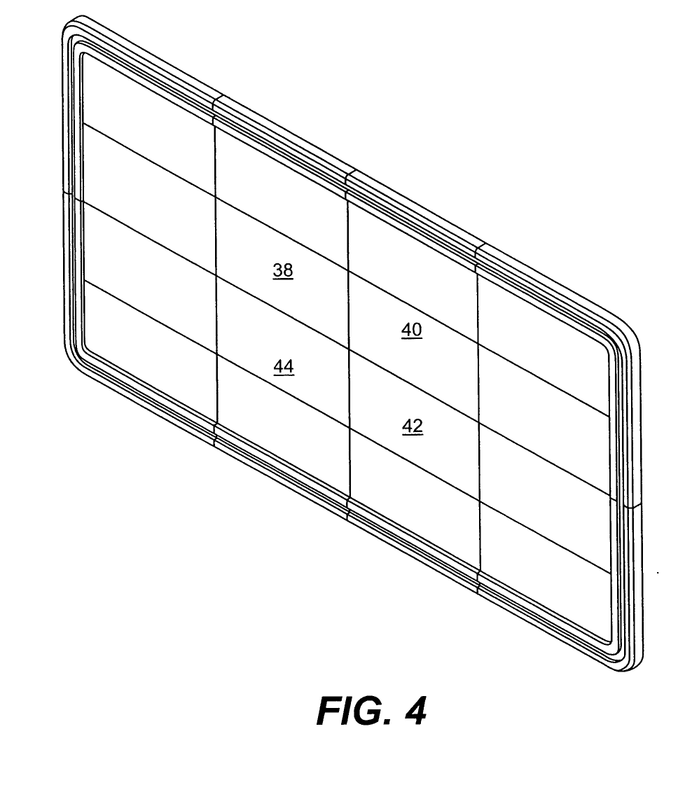

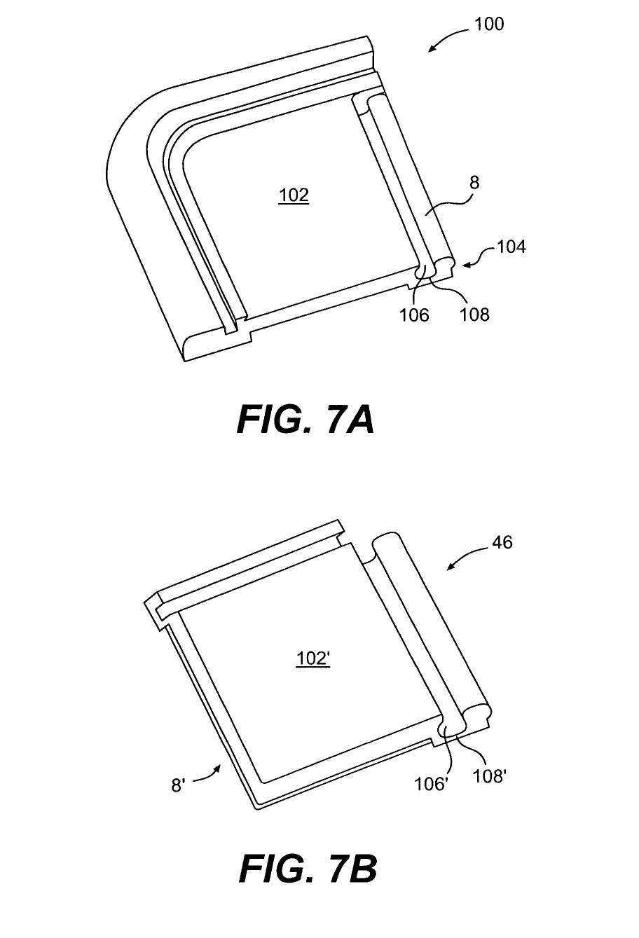

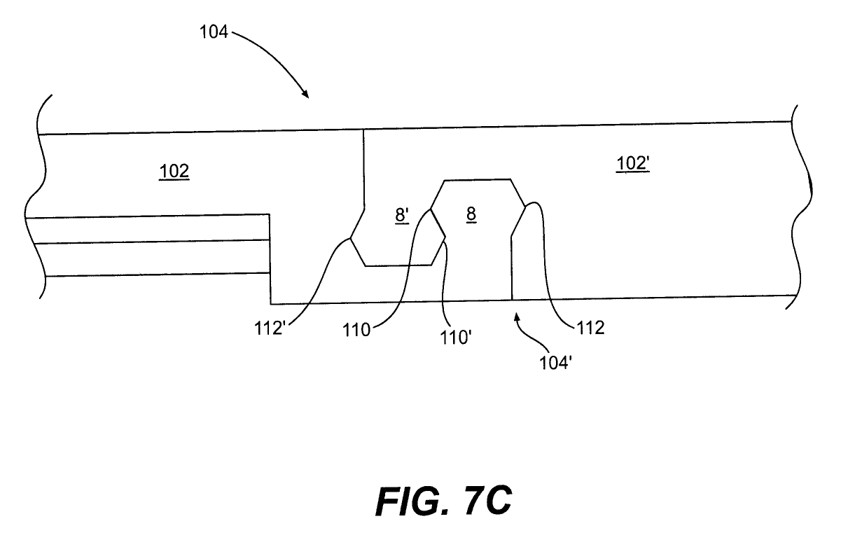

As shown in FIG. 4, embodiments of the modular display board 2 can also have inner sections 38, 40, 42 and 44 made up of a tertiary panel 46 (shown in FIG. 7b). The tertiary panel 46 is not configured to be used as an edge of the assembled modular display 2. Each of the edges of the tertiary panel 46 should include a ridge and channel like that of the hollow panel 4. However, panels with ridges on less than all of the edges are satisfactory depending on the use of the panel.

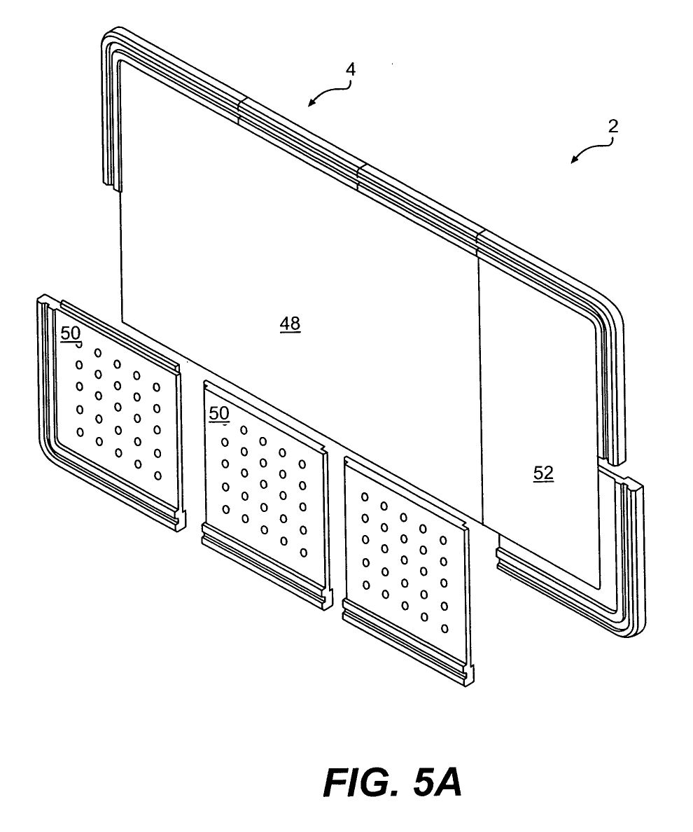

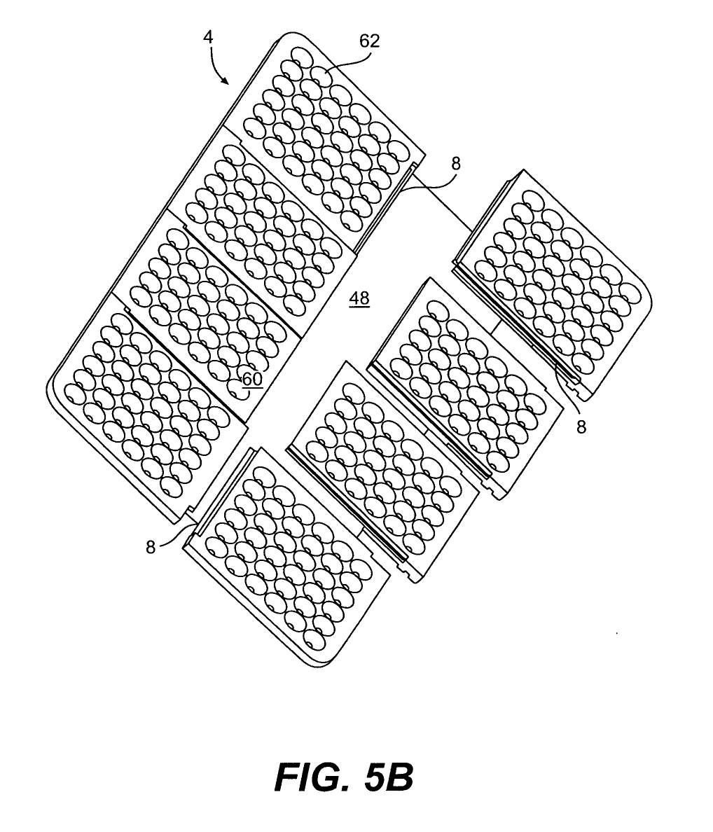

With reference to FIG. 5a, the modular display board 2 is shown in the process of being assembled for use as a writing board. A writing surface 48, which can be a dry-erasable material, blackboard material, paper, or other writing surface, can be added to a front surface 50 of the hollow panel 4, secondary panel 12, and tertiary panel 46 (not shown in this figure). Or, the front surface itself can be made of any of these materials, singularly or in combination with each other. When the modular display 2 board is used as a display board, without the writing surface 48, a tack surface 52 such as cork, pressure sensitive adhesive, felt, or any other material to which foreign items can be attached, can be attached to the front surface 50 of the modular display board 2; or the front surface can be made of any of these materials, singularly or in combination with each other. Also, the writing surface 48 can be used in conjunction with the tack surface 52 as shown in FIG. 5a.

With further reference to FIG. 3, a rim 54 of the hollow panel 4 can be configured such that a part of the rim 54 has a retaining lip 56 for receiving writing surface 48 or tack surface 52. Additionally, at least one part of the rim 54 can include a recess 58, which is adapted to be usable as a handle for the modular display board 2. The part of the rim 54 having the recess 58 can be either the same part of the rim 54 as that having the retaining lip 56 or the part of the rim 54 having the recess 58 can be a part of the rim 54 other than that having the retaining lip 56.

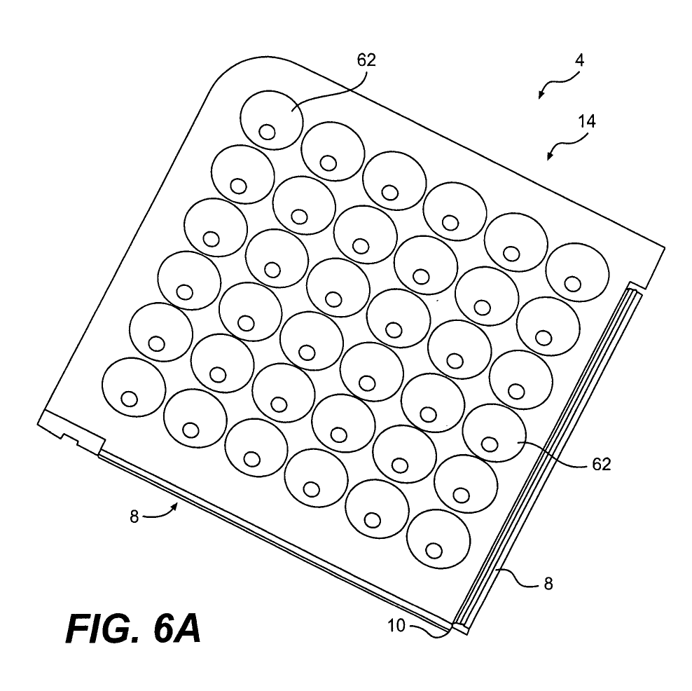

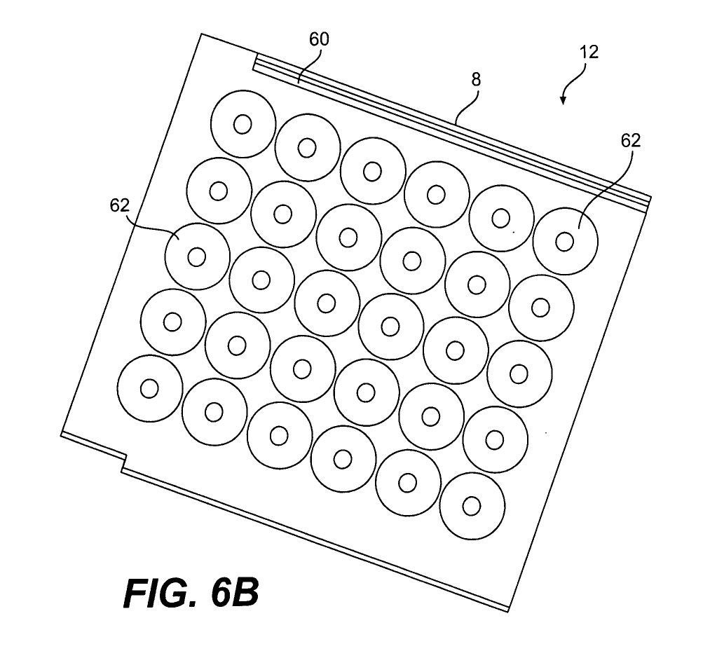

With reference to FIG. 5b, the rear surface 60 of the modular display board 2 can be planar or it can include at least one indentation 62. The indentation 62 is usable as a storage space, a mounting recess, or a primary handle for holding the modular display board by the rear surface. The indentation 62 can also be used as a secondary handle usable in conjunction with recess 58. FIGS. 6a and 6b, respectively, emphasize rear surfaces of corner section 14 and secondary panel 12.

Each panel has a panel body portion 102 or 102′ as seen, for example, in FIGS. 7a and 7b, respectively. FIG. 7a shows a corner portion 100 of a display board; and FIG. 7b shows an interior portion 46 of a display board. Though not entirely necessary, especially when only a single panel is being used as a display board, each panel should have at least one connection mechanism 104 along at least one of its edges. The connection mechanism 104 can be, for example, a ridge 8, spaced apart from the panel body portion 102 by a connection mechanism receiving recess 106 (or 106′ in FIG. 7b). However, the connection mechanism can be any other mechanism suitable for engaging an adjoining panel of a modular display board. The ridge 8 is connected to and spaced apart from the panel body portion 102 by the connection mechanism connection bridge 108. A ridge of one panel connects to a ridge of another panel by either snapping the ridges together or by sliding them together.

It is not necessary that a panel have ridges on all of its sides. For example, a panel can have a ridge on none of its sides if the panel is not intended to be used with any other panels; or a panel can have a ridge on only one side for connection to only a single additional panel. When only a single edge is used for connection to a single additional panel, the additional panel can be the sole additional panel or a panel among a group of additional panels. Each ridge can connect to an identically shaped locking ridge of another panel or it can connect to an arbitrarily shaped locking ridge of another panel.

FIG. 7c shows a closer view of the locking ridge of the connection mechanism 104. In this figure, the connection mechanism 104 is joined to connection mechanism 104′ of an arbitrary panel. Panel 102 is connected to panel 102′ by locking ridges 8 and 8′. Each locking ridge should have at least one protrusion 110 and 110′ on a side of the ridge either adjacent the connection mechanism receiving recess 106 or opposite the connection mechanism receiving recess 106. The protrusion 110 helps to lock the ridge 8 inside the connection mechanism receiving recess 106. Additionally, the ridges can also include second protrusions 112 and 112′. Ridge protrusions 110, 110′, 112 and 112′ can have sharp corners like that depicted in FIG. 7c or the ridge protrusions can have rounded edges. The ridge protrusions are not necessary in all embodiments of the display board. In place of the protrusions, Velcro can be used to secure one panel to another; releaseable adhesives can be used, or a magnetic assembly can be used. The connection mechanism 104 shown in FIG. 7c is shown as a ship-lapped groove on the panel's edge. However, the connection mechanism 104 does not have to be limited to a ship-lapped groove; it can be any configuration that allows a panel to join with another panel. For example, the connection mechanism can be a magnetic butt-to-butt type mechanism where each panel is magnetically connected to another. Or the connection mechanism can be an overlapping adhesive type connection where edges of the panel are configured to overlap with an edge of another panel and maintain contact with each other through the use of adhesives or magnets.

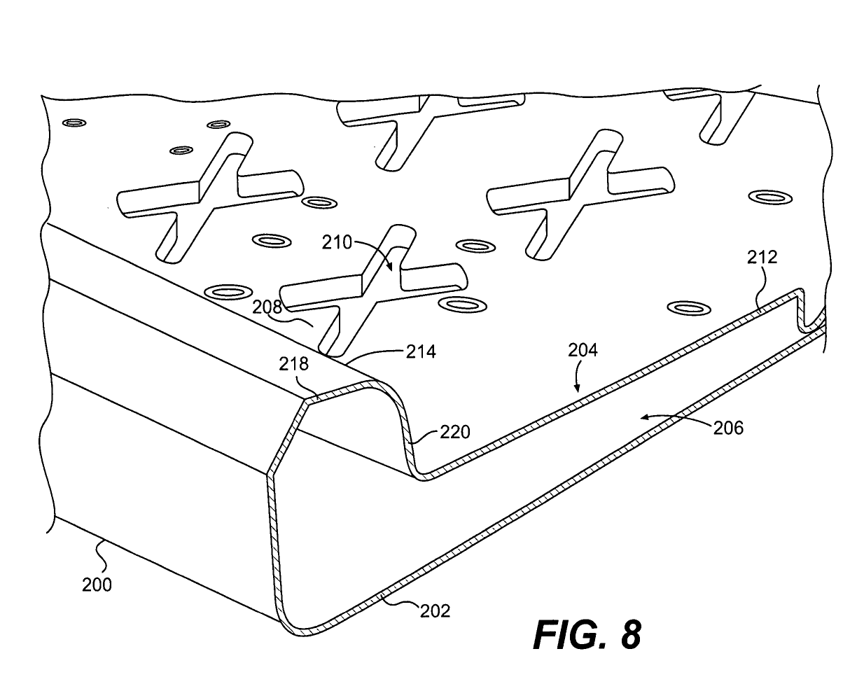

FIG. 8 shows a hollow panel 200 of a modular display board. At least one of the panels 200 of this embodiment of the modular display board can have three layers—a front layer 202 and a rear layer 204 sandwiching an inner air layer 206. The rear layer 204 can be planar or can include a channeled cross section such that, when looked at from its edge, includes peaks 208, valleys 210 and linear sections 212. The locations of the peaks 208, valleys 210, and linear sections 212 in the cross-section can vary around the area of the rear surface. With this variance in locations of peaks 208, valleys 210, and linear sections 212, different indentations can be formed in the rear surface so that the channeled areas of the rear surface of this embodiment of the modular display board can be used as a storage space, mounting recess, or a handle for holding the modular display board by the rear surface.

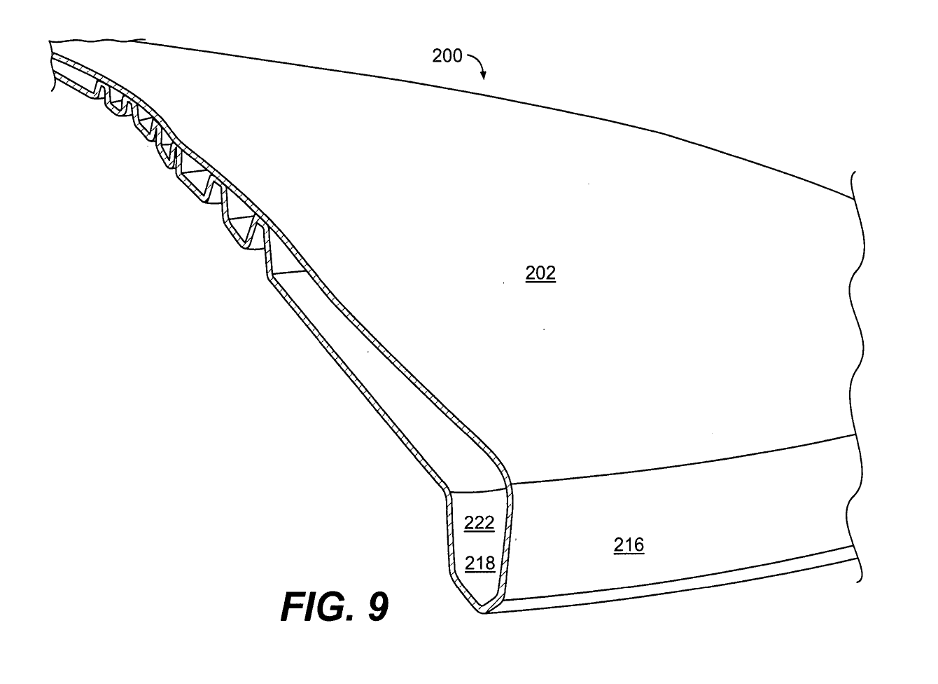

As shown in FIG. 9, the front layer 202 of the hollow panel 200 does not need to include any type of tack surface or writing surface. The hollow display panel 200 can be made simply as a flat panel for any type of use requiring a flat surface. Also, the front layer 202 can be made of the same material as the rear layer 204 or the front layer 202 can be made of a different material than the rear layer 204. For example, the front layer 202 can be made of dry erase sheets, blackboard material, paper, a tack surface such as cork, felt, or any other material to which foreign items can be attached. One type of material can be used alone or combination with another type of material. For example, half of the front layer 202 can be made of a writing surface such as a dry erase sheet or blackboard and the other half of the writing surface can be made of cork.

Also, of particular visibility in this figure is a rear rim 214. Like the rest of the hollow panel 200, the rear rim 214 can be hollow. The rear rim 214 is generally located around an edge of the hollow panel 200 on the rear layer 204. The rear rim 214 can be generally configured such that a side layer 216 extends from an edge of the front layer 202 acting as a limit to the inner air layer 206 and extending beyond the rear layer 204. Rim rear surface 218 connects the side layer 216 with a rear rim return portion 220. The rear rim return portion 220 connects the rim rear surface 218 with the rear layer 204. The rear rim 214 can be used as a handle for carrying larger hollow panels. Or, the rear rim 214 can be used as a retaining wall if using the hollow panel as a storage compartment. For example, any of various materials can be placed on the rear surface 204 of the hollow panel 200 and prevented from falling off of the rear surface by rear rim 214.

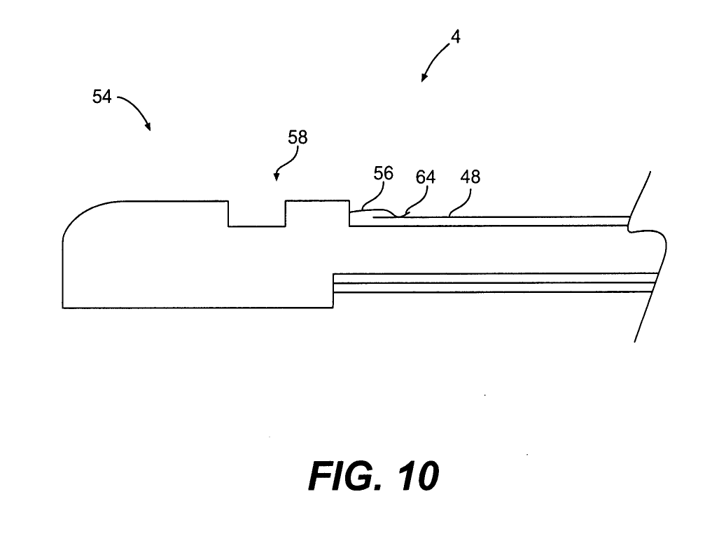

FIG. 10 shows a cross-sectional view of rim 54 of the hollow panel 4 shown in FIG. 3. The rim 54 has a recess 58 that provides enhanced manipulability when using the rim 54 as a handle for carrying the hollow panel 4 (or the entire display board). The recess 58 provides relief for a person's fingers when carrying the hollow panel 4. Also attached to rim 54 is a retaining lip 56 for retaining writing surface materials 48 such as dry erase sheets, blackboard material, paper, etc. The retaining lip is near the edge of the face of hollow panel. Alternatively, the retaining lip 56 can be used to retain any other type of material such as a tack surface such as cork, a writing surface backed with a pressure sensitive adhesive, felt, or any other material to which foreign items can be attached. The retaining lip 56 can include a release tab 64 for use when releasing the writing surface material 48. It is not required that each of the panels of an assembled modular display board have both a retaining lip 56 and a recess 58. It is sufficient that any one of the panels of an assembled modular display board have one, both or none of either feature. It is equally acceptable for neither of these features—a retaining lip and a recess—to be present in an assembled modular display board.

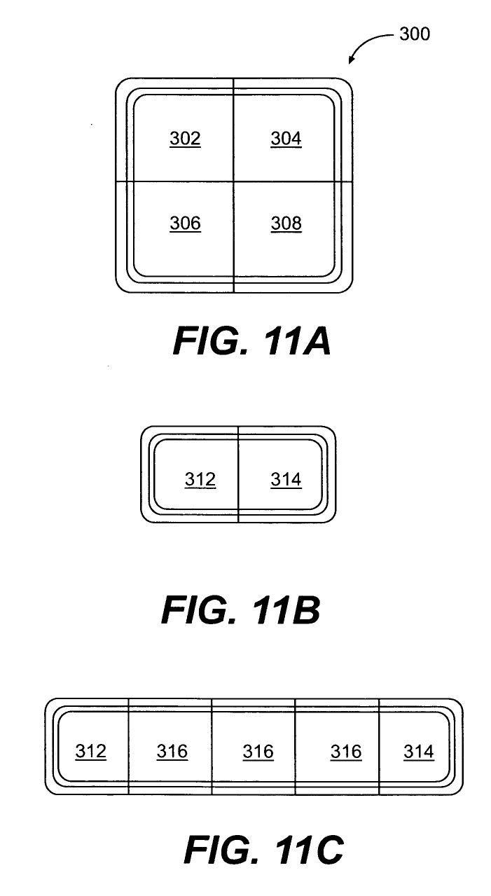

With reference to FIG. 11a, each of the interlocking panels of this embodiment of the modular display board can act as a separate corner section of the modular display board. For example, modular board 300 having four panels 302, 304, 306, and 308 will be configured such that one of the corners of each of the four panels will be a corner of the assembled modular board. As shown in FIG. 11b, a modular board having two panels 312 and 314 can be configured such that two of the corners of one panel are two of the corners of the assembled board and two of the corners of the remaining panel are the other two corners of the assembled modular board. With reference to FIG. 11c, the modular display board can be used with edge sections 312 and 314 and inner sections 316, which are double edged panels. Double edged panels 316 are those panels having two opposing edges serving as opposing edges of an assembled modular display board. Placing double edged panels 316 between two end panels 312 and 314 creates an elongated modular display board.

An assembled modular display board can have infinitely numerous shapes such as round, triangular, trapezoidal, rectangular, or any other shape that suits a user's desires. Also, an assembled modular display board can be configured three-dimensionally where each of the corner sections of the display board is molded to have a surface in each of three axes, which all come together at a common vertex. Thus, for example, the panels can be configured to form a cube, a pyramid, or any other three-dimensional structure.

It can be appreciated that the above described modular display board can be realized in a variety of embodiments and that those described hereinabove are merely examples.

I claim:

1. A display board comprising:
at least one hollow panel having a rear surface and a front surface,
said hollow panel having a ridge along at least one edge of said hollow panel, said ridge comprising a channel that is interlockable with a ridge of a second panel.

2. The display board of claim 1 wherein said hollow panel is a blow-molded panel.

3. The display board of claim 2 wherein said front surface comprises a dry-erasable surface.

4. The display board of claim 2 wherein said front surface comprises a tack surface.

5. The display board of claim 1 further comprising a plurality of secondary panels.

6. The display board of claim 5 wherein said at least one hollow panel and at least one of said plurality of secondary panels each comprise a separate corner section of the display board.

7. The display board of claim 6 further comprising an inner section comprising at least one tertiary panel.

8. The display board of claim 1 wherein said at least one hollow panel comprises an edge having a retaining lip for receiving a dry-erasable surface.

9. The display board of claim 1 wherein said at least one hollow panel comprises an edge having a recess adapted to be a handle for the display board.

10. The display board of claim 9 wherein said at least one hollow panel further comprises a retaining lip for receiving a dry-erasable surface.

11. The display board of claim 1 wherein said rear surface further comprises at least one indentation.

12. A display board comprising:
a plurality of interlocking panels releasably attached to each other,
each of said plurality of interlocking panels comprising a joint engaging member along at least one edge thereof for interlocking each of said plurality of interlocking panels with another of said plurality of interlocking panels.

13. The display board of claim 12 wherein at least one of said plurality of interlocking panels further comprises a front layer in communication with an inner air layer and a rear layer in communication with said inner air layer opposite said front layer.

14. The display board of claim 13 wherein said front layer comprises a dry-erasable surface.

15. The display board of claim 13 wherein said front layer comprises a tack surface.

16. The display board of claim 13 wherein said rear layer comprises a channeled cross-section.

17. The display board of claim 12 wherein each of said plurality of interlocking panels comprises a corner of the display board.

18. The display board of claim 12 wherein at least two of said plurality of interlocking panels each comprise a separate corner of the display board.

19. The display board of claim 18 wherein remaining panels of said plurality of interlocking panels each comprise a separate inner section of the display board.

20. The display board of claim 12 wherein each of said plurality of interlocking panels comprise an edge having a retaining lip for receiving a dry-erasable surface.

21. The display board of claim 12 wherein each of said plurality of interlocking panels comprise an edge having a recess adapted to be a handle for the display board.

22. The display board of claim 21 wherein each of said plurality of interlocking panels further comprise a retaining lip for receiving a dry-erasable surface.

23. A display board comprising:
a first blow-molded panel comprising a ship-lapped groove on an edge of said blow-molded panel,
said ship-lapped groove of said first blow-molded panel adapted to interlockingly communicate with a ship-lapped groove of a second panel.

24. The display board of claim 23 wherein said first blow-molded panel further comprises a front layer and an indented rear layer.

25. The display board of claim 24 wherein said front layer comprises a dry-erasable surface.

26. The display board of claim 24 wherein said front layer comprises a tack surface.

27. The display board of claim 23 wherein said first blow-molded panel comprises a corner of the display board.

28. The display board of claim 27 further comprised of an inner section comprised of at least a second panel attached to said first blow-molded panel.

29. The display board of claim 24 wherein said front layer of said first blow molded panel further comprises an edge having a retaining lip for receiving a dry-erasable surface.

30. The display board of claim 24 wherein said first blow-molded panel comprises an edge having a recess adapted to be a handle for the display board.

31. The display board of claim 30 wherein said front layer of said first blow-molded panel further comprises a retaining lip for receiving a dry-erasable surface when said plurality of panels.

32. A display board comprising
a plurality of separable sections, each of said separable sections comprising an interlocking mechanism; and
a rail along at least one edge of a face of each of said plurality of separable sections.

33. The display board of claim 32 wherein said plurality of separable sections each comprise a dry-erase sheet attachment ridge substantially near said at least one edge of said face of said plurality of separable sections.

34. The display board of claim 32 wherein at least one of said plurality separable sections further comprises a front layer attached to an inner air layer and
a rear layer attached to said inner air layer opposite said front layer.

35. The display board of claim 34 wherein said front layer comprises a dry-erasable surface.

36. The display board of claim 34 wherein said front layer comprises a tack surface.

37. The display board of claim 34 wherein said rear layer comprises an irregular cross-section.

38. The display board of claim 32 wherein each of said plurality of separable sections comprises a corner of the display board.

39. The display board of claim 32 wherein four of said plurality of separable sections each comprises a separate corner of the display board and each remaining section of said plurality of separable sections comprise a separate inner section of the display board.
